(19) United States
(12) Patent Application Publication
(10) Pub. No.: US 2010/0101053 A1
(43) Pub. Date: Apr. 29, 2010

(54) HINGE ASSEMBLY

(75) Inventors: Xiao-Bo LI, Shenzhen City (CN); Jin-Xin Wang, Shenzhen City (CN); Jian Li, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/396,557

(22) Filed: Mar. 3, 2009

(30) Foreign Application Priority Data
Oct. 24, 2008 (CN) 200810305177.7

(51) Int. Cl. E05D 11/08; E05D 11/10

(52) U.S. Cl. 16/341; 16/319

(57) ABSTRACT

A hinge assembly includes a rotatable shaft, a rotatable stand, a fixed stand, a cam and a cam follower. The rotatable stand and the cam follower are non-rotatably connected to the rotatable shaft. The fixed stand and the cam are rotatably connected to the rotatable shaft. The cam is fixed to the fixed stand and contacted with the cam follower. The cam forms a limiting step, the cam follower forms a limiting surface on a periphery to abut against the limiting step. One of the cam and cam follower forms a positioning protrusion, the other one of the cam and cam follower defines a positioning groove to engage with the positioning protrusion.

### BACKGROUND

1. Technical Field

The present disclosure relates generally to hinge assemblies and, more particularly, to a hinge assembly used in an electronic device.

2. Description of Related Art

An electronic device such as a mobile phone, a notebook computer, or a personal digital assistant, generally has a main body and a display cover pivotally mounted on the main body via a hinge assembly.

A typical hinge assembly includes a shaft, a rotatable stand, a fixed stand, a restricting member, a fixing member, a positioning member, a plurality of resilient washers, and a nut. The restricting member defines a limiting groove. The fixed stand forms a limiting protrusion. The positioning member forms a plurality of positioning protrusions. The fixing member defines a plurality of positioning recesses corresponding to the positioning protrusions. In assembly, the shaft is passed through the rotatable stand, the restricting member, the fixed stand, the fixing member, the positioning member, and the spring washers, before engaged with the nut. The fixing member is fixed on the fixed stand. The rotatable stand, the restricting member, and the positioning member follow the rotation of the shaft relative to the fixed stand and the fixing member.

In use, the rotatable stand with the shaft is rotated relative to the fixed stand, thus driving the restricting member and the positioning member to rotate. The limiting protrusion of the fixed stand slides in the limiting groove of the restricting member, thereby limiting a rotating range of the rotatable stand. When the rotatable stand reaches a predetermined position, the positioning protrusions engage in the positioning recesses, thus retaining the rotatable stand in the present position.

However, the limiting protrusion of the fixed stand is easily abraded or damaged by an exterior force, so that the typical hinge assembly has a low impact resistance and an unsatisfactory limiting effect. Moreover, the typical hinge assembly has too many components to realize the limiting and positioning functions, thus causing a high production cost.

What is needed, therefore, is a new hinge assembly that overcomes the above mentioned disadvantages.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an exploded, isometric view of a first embodiment of the hinge assembly, the hinge assembly including a cam follower.

FIG. 2 is an isometric view of the cam follower of the hinge assembly in FIG. 1.

FIG. 3 is similar to the FIG. 1, but viewed from another aspect.

FIG. 4 is an assembled, isometric view of the hinge assembly in FIG. 1.

FIG. 5 is a side, cross-sectional view of the hinge assembly in FIG. 4, taken along line V-V.

FIG. 6 is a side, cross-sectional view of a second embodiment of the hinge assembly.

FIG. 7 is a side, cross-sectional view of a third embodiment of the hinge assembly, showing the hinge assembly rotated in a first position.

FIG. 8 is similar to the FIG. 7, but showing the hinge assembly rotated in a second position.

### DETAILED DESCRIPTION OF THE EMBODIMENTS

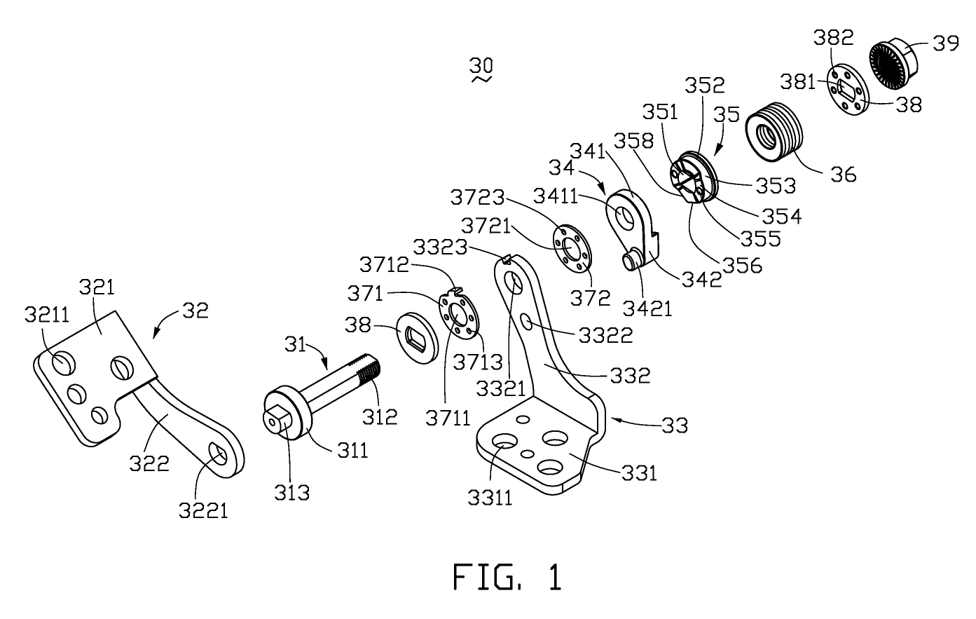

Referring to FIG. 1, a first embodiment of a hinge assembly 30 includes a rotatable shaft 31, a rotatable stand 32, a fixed stand 33, a cam 34, a cam follower 35, an elastic member 36, a first friction member 371, a second friction member 372, two washers 38, and a fastening member 39.

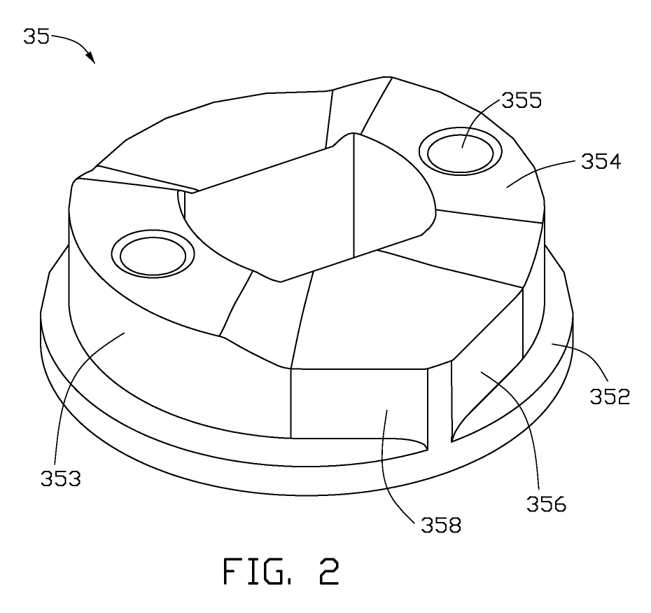

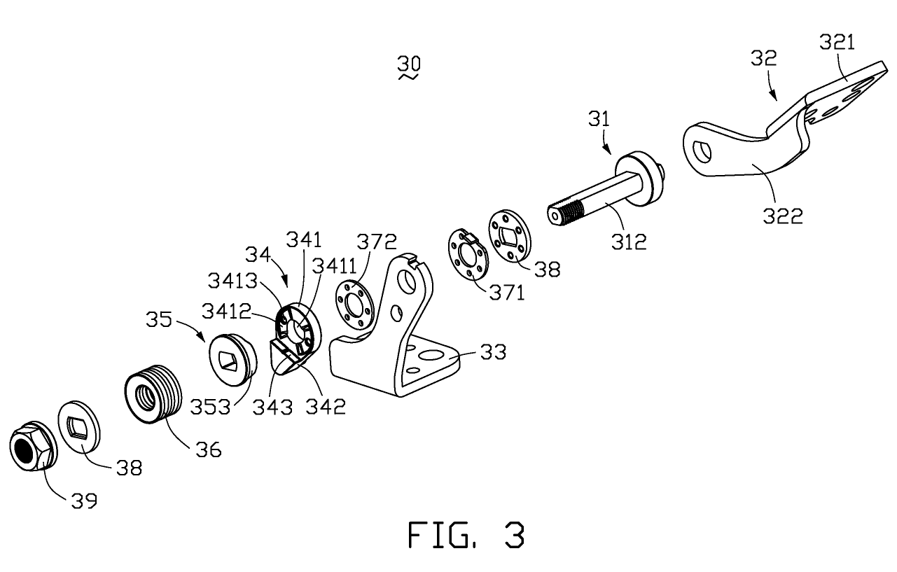

Referring also to FIGS. 2 and 3, a cross-section of the rotatable shaft 31 perpendicular to a central axis of the rotatable shaft 31 may be double-D shaped. A flange 311 is formed on a first end of the rotatable shaft 31, and a threaded portion 312 is formed on a second end of the rotatable shaft 31. A shaft head 313 extends from the flange 311 along an extending direction of the rotatable shaft 31.

The rotatable stand 32 includes a flat plate 321. The flat plate 321 defines a plurality of fixing holes 3211. An arched positioning piece 322 extends substantially perpendicularly from a side of the flat plate 321. The positioning piece 322 defines a non-circular pivot hole 3221 having a shape corresponding to the shape of the shaft head 313 of the rotatable shaft 31.

The fixed stand 33 includes a fixing plate 331 and a supporting plate 332 extending substantially perpendicularly from a side of the fixing plate 331. The fixing plate 331 defines a plurality of fixing holes 3311. The supporting plate 332 defines a circular pivot hole 3321 in an end away from the fixing plate 331, and an assembling hole 3322 in a middle portion. The supporting plate 332 also defines an assembling cutout 3323 adjacent to the pivot hole 3321.

The cam 34 includes a substantially cylindrical assembling portion 341 and a restricting portion 342 formed at an end of the assembling portion 341. In the illustrated embodiment, the restricting portion 342 is substantially triangular-shaped. A thickness of the restricting portion 342 is larger than that of the assembling portion 341, thus forming a limiting step 343. A center of the assembling portion 341 defines a circular cam hole 3411. The assembling portion 341 also defines two positioning grooves 3412 in a side surface. A bottom surface of each positioning groove 3412 defines a lubricant groove 3413. A fixing pole 3421 extends from the restricting portion 342.

The cam follower 35 is substantially cylindrical. A center of the cam follower 35 defines a non-circular through hole 351 having a shape corresponding to the shape of the cross-section of the rotatable shaft 31. The cam follower 35 forms a flange 352 on an end, and two positioning protrusions 354 on a side surface away from the flange 352. A top surface of each positioning protrusion 354 defines a lubricant groove 355. The cam follower 35 forms a partial cylindrical surface 353, a limiting surface 356 and a connecting surface 358 on a periphery. The limiting surface 356 and the connecting surface 358 may both be flat surfaces. First ends of the limiting surface 356 and the connecting surface 358 may be connected to each other. Second ends of the limiting surface 356 and the connecting surface 358 are smoothly adjoined to the partial cylindrical surface 353. In the illustrated embodiment, an edge between the first ends of the limiting surface 356 and the connecting surface 358 is rounded.

In alternative embodiments, the positioning protrusions 354 may be formed on the cam 34, and the positioning grooves 3412 may be defined in the cam follower 35. In addition, the number of the positioning protrusions 354 and the corresponding number of the positioning grooves 3412 may be any desired number, such as one, three, five, or more.

In the illustrated embodiment, the elastic member 36 is a plurality of spring washers. However, the elastic member 36 may be other elastic members, such as a helical spring.

The first friction member 371 defines a circular through hole 3711 in a center portion, and forms a positioning piece 3712 on an edge portion to engage in the assembling cutout 3323 of the fixed stand 33. The first friction member 371 also defines a plurality of lubricant grooves 3713 in a side surface.

The second friction member 372 defines a circular through hole 3721 in a center portion and a plurality of lubricant grooves 3723 in a side surface.

Each washer 38 defines a non-circular through hole 381 in a center portion, and a plurality of lubricant grooves 382 in a side surface.

The fastening member 39 engages with the threaded portion 312 of the rotatable shaft 31 to keep the components between the flange 311 and the fastening member 39 together. The fastening member 39 may be a nut, for example.

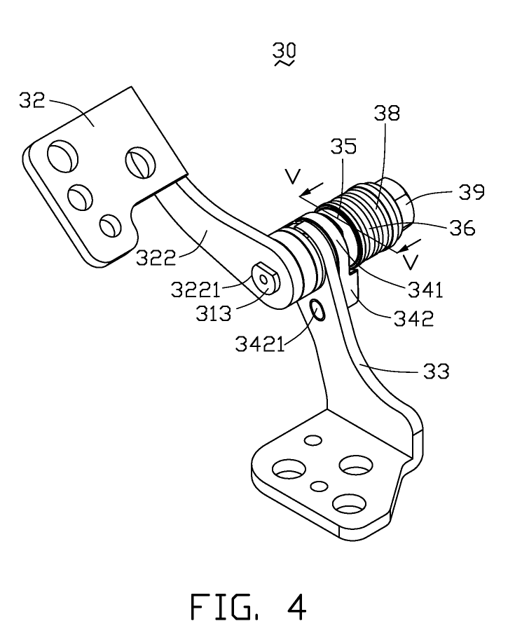

Referring also to FIG. 4, the rotatable shaft 31 passes through one washer 38, the first friction member 371, the pivot hole 3321 of the fixed stand 33, the second friction member 372, the cam hole 3411 of the cam 34, the through hole 351 of the cam follower 35, the elastic member 36, the other washer 38, and engages with the fastening member 39. The positioning piece 3712 of the first friction member 371 engages in the assembling cutout 3323 of the fixed stand 33. The fixing pole 3421 of the cam 34 extends into the assembling hole 3322 of the fixed stand 33. The positioning protrusions 354 of the cam follower 35 engage in the corresponding positioning grooves 3412 of the cam 34. The shaft head 313 engages in the pivot hole 3221 of the rotatable stand 32. Therefore, the rotatable stand 32, the cam follower 35 and the washers 38 are non-rotatably connected to the rotatable shaft 31. The fixed stand 33 and the cam 34 are rotatably connected to the rotatable shaft 31.

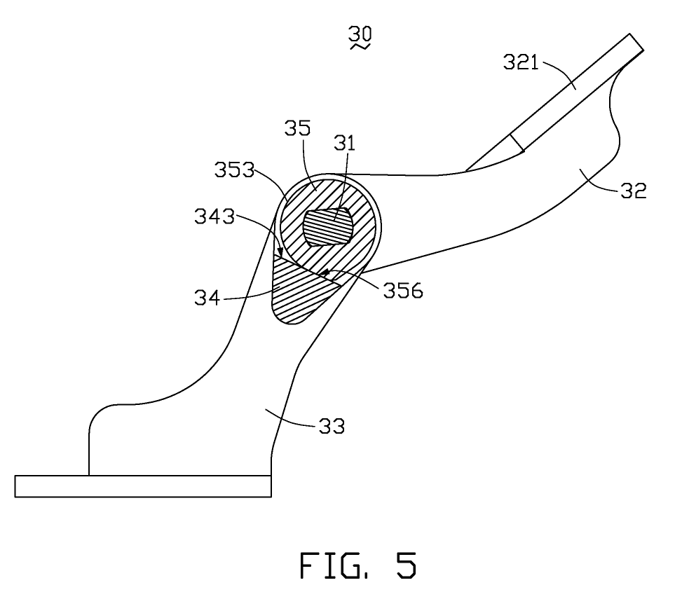

Referring also to FIG. 5, when opening the hinge assembly 30, the rotatable stand 32 rotates with the rotatable shaft 31, for example, in a clockwise direction, thus driving the cam follower 35 to rotate. The partially cylindrical surface 353 of the cam follower 35 rotates on the limiting step 343 of the cam 34, until the limiting surface 356 of the cam follower 35 abuts against the limiting step 343. In such time, the rotatable stand 32 has reached a largest angle relative to the fixed stand 33, and cannot rotate further along the clockwise direction. Simultaneously, the positioning protrusions 354 of the cam follower 35 engage in the corresponding positioning grooves 3412 of the cam 34, thereby maintaining an angle between the rotatable stand 32 and the fixed stand 33.

When closing the hinge assembly 30, the rotatable stand 32 rotates with the rotatable shaft 31, for example, in a counterclockwise direction, thus driving the cam follower 35 to rotate. The partial cylindrical surface 353 of the cam follower 35 rotates on the limiting step 343 of the cam 34, until the flat plate 321 of the rotatable stand 32 becomes parallel to the fixing plate 331 of the fixed stand 33. In such time, the rotatable stand 32 has reached a closed position relative to the fixed stand 33. During the opening or closing process, the rotatable stand 32 can remain in any position (angle) relative to the fixed stand 33, because of frictional forces generated between the components of the hinge assembly 30.

When the hinge assembly 30 is applied in an electronic device (not shown), the rotatable stand 32 and the fixed stand 33 are fixed on a display cover and a main body of the electronic device, respectively. The limiting surface 356 of the cam follower 35 may abut against the limiting step 343 of the cam 34, thus limiting the rotatable range of the rotatable stand 32. The hinge assembly 30 has a good impact resistance and a satisfied limiting effect because the limiting surface 356 of the cam follower 35 is not easily abraded or damaged by external forces. In addition, the positioning protrusions 354 of the cam follower 35 may engage in the corresponding positioning grooves 3412 of the cam 34, thus retaining the rotatable stand 32 in a desired position. Therefore, the hinge assembly 30 realizes the limiting and positioning functions via the cam follower 35, and a positioning member in the typical hinge assembly can be omitted. Thus, a production cost of the hinge assembly 30 is lower, and an occupying space of the hinge assembly 30 is reduced. Moreover, the cam 34, the cam follower 35, the friction members 371, 372 and the washers 38 cooperatively define lubricant grooves to reduce wear and tear, so a usage life of the hinge assembly 30 is prolonged.

In an alternative embodiment, the rotatable stand 32 may be omitted, and the display cover may be directly fixed to the shaft head 313 of the rotatable shaft 31.

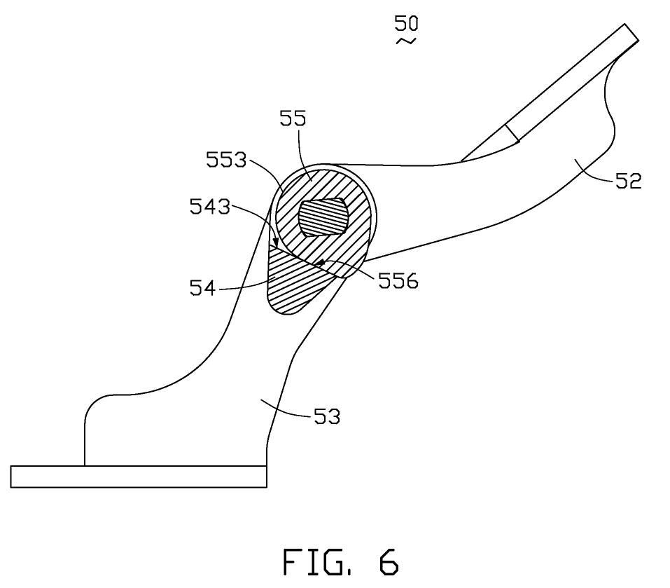

Referring to FIG. 6, a second embodiment of a hinge assembly 50 is similar to the first embodiment of the hinge assembly 30, except that a cam follower 55 forms a partial cylindrical surface 553 and a limiting surface 556 on a periphery, and omits a connecting surface. The limiting surface 556 is a flat surface, and an end of the limiting surface 556 is smoothly adjoined to the partial cylindrical surface 553.

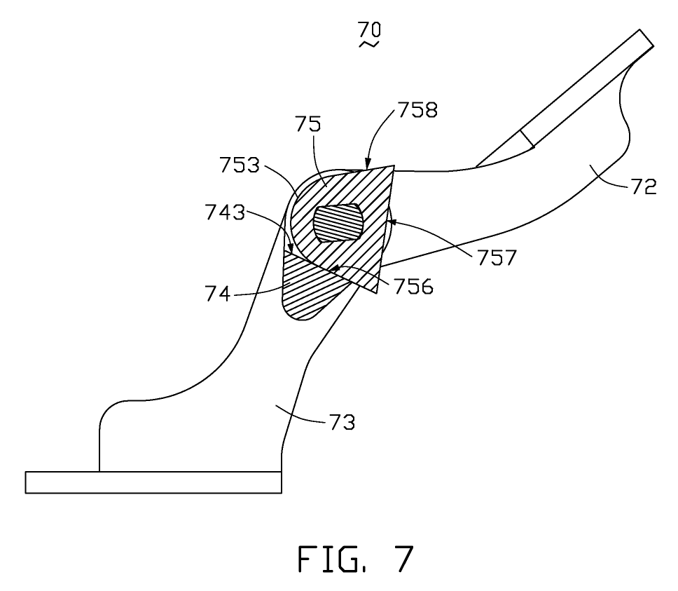

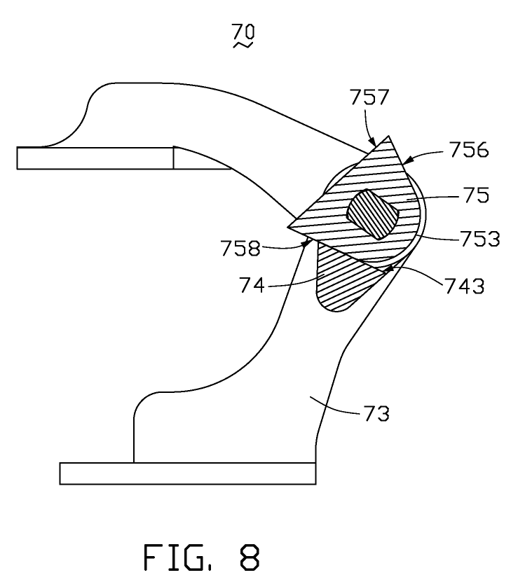

Referring to FIGS. 7 and 8, a third embodiment of a hinge assembly 70 is similar to the first embodiment of the hinge assembly 30, except that a cam follower 75 forms a partial cylindrical surface 753, a first limiting surface 756, a connecting surface 757, and a second limiting surface 758 on a periphery. The first and second limiting surfaces 756, 758 and the connecting surface 757 are all flat surfaces. First ends of the first and second limiting surfaces 756, 758 are connected to the connecting surface 757. Second ends of the first and second limiting surfaces 756, 758 are smoothly adjoined to the partial cylindrical surface 753.

In the third embodiment, when the first limiting surface 756 abuts against a limiting step 743 of a cam 74, the rotatable stand 72 has reached a largest angle relative to the fixed stand 73. When the second limiting surface 758 abuts against the limiting step 743 of the cam 74, the rotatable stand 72 has reached a closed position relative to the fixed stand 73. Therefore, the hinge assembly 70 has a good limiting function both at the opened and closed positions. When the hinge assembly 70 is applied in an electronic device, a shock or impact of a display cover due to closure is reduced, and possibly avoided.

In alternative embodiments, the shape of the connecting surface 757 may be varied, for example, the connecting surface 757 may be a curved surface or a plurality of flat surfaces connected each other. The rotatable range of the rotatable stand 72 may be varied by changing the relative positions of the first and second limiting surface 756, 758. An edge between the first or second limiting surface 756, 758 and the connecting surface 757 may be rounded.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A hinge assembly, comprising:
a rotatable shaft;
a rotatable stand non-rotatably connected to the rotatable shaft;
a fixed stand rotatably connected to the rotatable shaft;
a cam rotatably connected to the rotatable shaft, and fixed to the fixed stand; and
a cam follower non-rotatably connected to the rotatable shaft, and contacting the cam;
wherein the cam forms a limiting step thereon, the cam follower forms a limiting surface on a periphery thereof to abut against the limiting step; one of the cam and cam follower forms a positioning protrusion thereon, the other one of the cam and cam follower defines a positioning groove therein to engage with the positioning protrusion.

2. The hinge assembly of claim 1, wherein the cam follower further forms a partial cylindrical surface and a connecting surface on the periphery; a first end of the limiting surface is connected to the connecting surface, a second end of the limiting surface is smoothly adjoined to the partial cylindrical surface.

3. The hinge assembly of claim 2, wherein the limiting surface and the connecting surface both are flat surfaces, an end of the connecting surface away from the limiting surface is smoothly adjoined to the partial cylindrical surface.

4. The hinge assembly of claim 1, wherein the cam follower further forms a partial cylindrical surface on the periphery; the limiting surface is a flat surface, and an end of the limiting surface is smoothly adjoined to the partial cylindrical surface.

5. The hinge assembly of claim 1, wherein the cam comprises an assembling portion and a restricting portion formed at an end of the assembling portion; a thickness of the restricting portion is larger than that of the assembling portion, thus forming the limiting step.

6. The hinge assembly of claim 1, wherein a fixing pole is formed on the cam; the fixed stand defines an assembling hole; the fixing pole is fixedly received in the assembling hole of the fixed stand.

7. The hinge assembly of claim 1, wherein a cross-section of the rotatable shaft perpendicular to a central axis thereof is double-D shaped; the fixed stand defines a circular pivot hole; the cam defines a circular cam hole; the cam follower defines a non-circular through hole corresponding to the shape of the cross-section of the rotatable shaft; the rotatable shaft is inserted through the circular pivot hole of the fixed stand, the circular cam hole of the cam and the non-circular through hole of the cam follower.

8. The hinge assembly of claim 1, wherein the rotatable shaft has a shaft head; the rotatable stand defines a non-circular pivot hole corresponding to the shape of the shaft head; the shaft head is fixedly inserted in the non-circular pivot hole of the rotatable stand.

9. The hinge assembly of claim 1, wherein a threaded portion is formed at an end of the rotatable shaft; the hinge assembly further comprises a fastening member to engage with the threaded portion.

10. The hinge assembly of claim 1, further comprising an elastic member sleeved on the rotatable shaft to generate an elastic force along the rotatable shaft.

11. The hinge assembly of claim 10, wherein the elastic member comprises a plurality of spring washers.

12. The hinge assembly of claim 1, further comprising two friction members sleeved on the rotatable shaft, and positioned at opposite sides of the fixed stand.

13. The hinge assembly of claim 12, wherein at least one of the friction members, the cam, and the cam follower defines a plurality of lubricant grooves.

14. The hinge assembly of claim 12, wherein one of the friction members forms a positioning piece; the fixed stand defines an assembling cutout in an edge thereof; the positioning piece is fixedly received in the assembling cutout of the fixed stand.

15. A hinge assembly, comprising:
a rotatable shaft;
a fixed stand rotatably connected to the rotatable shaft;
a cam rotatably connected to the rotatable shaft, and fixed to the fixed stand; and
a cam follower non-rotatably connected to the rotatable shaft, and contacting the cam;
wherein the cam forms a limiting step thereon, the cam follower forms a first limiting surface and a second limiting surface on a periphery thereof; when the rotatable shaft rotates to a first position relative to the fixed stand, the first limiting surface abuts against the limiting step; when the rotatable shaft rotates to a second position relative to the fixed stand, the second limiting surface abuts against the limiting step.

16. The hinge assembly of claim 15, wherein the cam follower further forms a partial cylindrical surface on the periphery; first ends of the first and second limiting surfaces are smoothly adjoined to the partial cylindrical surface.

17. The hinge assembly of claim 16, wherein the cam follower further forms a connecting surface on the periphery; second ends of the first and second limiting surfaces are connected to the connecting surface.

18. The hinge assembly of claim 17, wherein the first and second limiting surfaces and the connecting surface are all flat surfaces.

19. The hinge assembly of claim 15, wherein one of the cam and cam follower forms a positioning protrusion thereon, the other one of the cam and cam follower defines a positioning groove therein to engage with the positioning protrusion.

20. The hinge assembly of claim 1, further comprising a rotatable stand; wherein the rotatable shaft has a shaft head; the rotatable stand defines a non-circular pivot hole corresponding to the shape of the shaft head; the shaft head is fixedly inserted in the non-circular pivot hole of the rotatable stand.
